(19) United States
(12) Patent Application Publication
(10) Pub. No.: US 2006/0266787 A1
(43) Pub. Date: Nov. 30, 2006

(54) ELECTRIC STAPLER

(75) Inventor: Toshikazu Ura, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/420,293

(22) Filed: May 25, 2006

(30) Foreign Application Priority Data
May 26, 2005 (JP) 2005-154398

(51) Int. Cl. B25C 5/02

(52) U.S. Cl. 227/131

(57) ABSTRACT

An electric stapler is provided. In this electric stapler, a driver arm is made to oscillate by making a toggle link mechanism operate by a connecting rod that performs a crank operation by a driving gear driven to rotate by a motor. A staple is put into sheets of paper by means of a driver provided at a top end of the driver arm by downward movement of the driver arm. A clinch arm is made to oscillate by a cam provided in the driving gear. Both legs of the staple penetrating through the sheets of paper are clinched by means of a clincher by upward turning of the clinch arm caused by a paper-thickness adjusting spring provided between the clinch arm and the toggle link mechanism. Due to this structure, driving load can be reduced and formation precision of each component does not affect clinching precision directly.

The present disclosure relates to subject matter contained in priority Japanese Patent Application No. 2005-154398, filed on May 26, 2005, the contents of which is herein expressly incorporated by reference in its entirety.

### BACKGROUND OF THE INVENTION

1. Field of the Invention

The present invention relates to an electric stapler. More particularly, the present invention relates to an electric stapler that reduces driving load in clinching.

2. Description of the Related Art

There are staplers having various structures. A stapler employing a flat-clinch type that clinches both legs of a staple put in sheets of paper to be flat has an advantage that, compared with a type that clinches both legs of a staple in an arch-like shape, a thickness of a site at which the sheets of paper are stapled is reduced with increase of stacked amount of document that are stapled. This flat-clinch type requires a structure for clinching both legs of a staple penetrating through sheets of paper by means of a clincher after the staple is made to penetrate through the sheets of paper.

As the aforementioned flat-clinch type electric stapler, a structure shown in FIGS. 6A to 8C is known (Japanese Patent Publication No. 2004-122247, for example). This electric stapler is configured to operate using AC power as a power source, as shown in FIGS. 6A and 6B. The AC power supplied through a power cord 121 is stepped down to a predetermined voltage by a power transformer 122 and is then rectified and smoothed to obtain DC power having a predetermined voltage. A DC motor 75 serving as a driving source is driven to rotate by that DC power.

As shown in FIGS. 7A to 7C, a pair of driving gears 85a and 85b are driven by rotation of the DC motor 75 via a driving mechanism 101 to rotate. Rotation of the driving gears 85a and 85b causes an oscillating arm 78 to oscillate, thereby moving a hammer 76 up and down. When the hammer 76 is moved down, one staple is pushed out from a staple array accommodated in a staple magazine and is put into sheets of paper. A hammering position of the hammer 76 changes in accordance with the thickness of the sheets of paper and is adjusted by changing a vertical position of a supporting shaft 88 of the oscillating arm 78 to respond to the change in the thickness of the sheets of paper. The supporting shaft 88 is biased downward by paper-thickness adjusting springs 91. Thus, a stable hammering force of the hammer 76 is ensured.

Immediately after the staple is put into the sheets of paper, a pin of a clinch arm 79 fitted with a cam groove 86 of the driving gears 85a and 85b is displaced to a position at which a formed radius of the cam groove 86 is large. Thus, the clinch arm 79 oscillates. Due to the oscillation of the clinch arm 79, a pressure-application piece 94 formed at a top end of the clinch arm 79 turns a pair of movable clinching plates 103a and 103b of a clincher 100, as shown in FIGS. 8A to 8C. Thus, both legs of the staple penetrating through the sheets of paper are clinched inward to be flat so that the sheets of paper are stapled together.

After the sheets of paper are stapled together, the driving gears 85a and 85b further rotate and a too end of the oscillating arm 78 starts to move up by a driving pin 80. Thus, the hammer 76 is driven to move up. In addition, the pin fitted with the cam groove 86 is displaced to a position at which the formed radius of the cam groove 86 is small, thereby causing the clinch arm 79 to oscillate in a direction in which the pressure-application piece 94 moves down. Thus, the pair of movable clinching plates 103a and 103b of the clincher 100 are moved back to their original positions. When the driving gears 85a and 85b are returned to angular positions shown in FIGS. 7A and 7B, a stop switch (not shown) operates to stop the rotation of the DC motor 75, thereby finishing a sequence of stapling operation.

In the aforementioned electric stapler of the conventional technique, the clinch arm 79 is made to oscillate by the cam groove 86 of the driving gears 85a and 85b after the staple is put into the sheets of paper. Therefore, especially in the case where the sheets of paper are thick, the clinch arm 79 oscillates with the paper-thickness adjusting springs 91 stretched. At this time, load on the DC motor 75 becomes the maximum. In order to overcome that load, the DC motor 75 has to be made larger. This increases power consumption.

Moreover, the clinch arm 79 is made to oscillate in a small range of a rotation angle in which the formed radius of the cam groove 86 formed in the driving gears 85a and 85b changes. Therefore, a large force is applied to a site of the cam groove 86 related to the radius change. For this reason, it is necessary to use a material having high strength such as metal for the driving gears 85a and 85b. This increases weight and cost.

In addition, a shaping state in which both legs of a staple are clinched varies in accordance with an angle of turning of a pair of movable clinching plates 103a and 103b provided in the clincher 100. When the angle of turning is insufficient, a clinching angle is also insufficient and a stapling condition is degraded. When the angle of turning is excessively large, the staple and sheets of paper are excessively pressed, so that a driving system is placed in an overload state. In order to improve this problem, an operation of the clincher 100 has to be adjusted appropriately. Therefore, it is necessary to process and assemble the cum groove 86, the clinch arm 79, and the clincher 100 with high precision, thus increasing the cost.

### BRIEF SUMMARY OF THE INVENTION

Therefore, it is an object of the present invention to provide an electric stapler that reduces driving load in clinching of a staple and is configured to prevent precision of each component from directly affecting the clinching of the staple.

In order to achieve the above object, an electric stapler according to the present invention includes: main driving means that is driven to rotate by a driving force from a motor; driver driving means that is moved up and down by a toggle link mechanism working with rotation of the main driving means; a driver that pushes out one staple from a staple array accommodated in a staple magazine and puts the staple into sheets of paper by downward movement of the driver driving means; a clinch arm that turns in connection with the rotation of the main driving means; a paper-thickness adjusting spring having an end connected to the toggle link mechanism and another end connected to the clinch arm; and clinching means that clinches both legs of the staple that is put into the sheets of paper by the driver to penetrate through the sheets of paper, by turning of the clinch arm and tension of the paper-thickness adjusting spring.

According to the above structure, the driver driving means is moved up and down by the toggle link mechanism that works with the main driving means to be driven. Thus, it is possible to move up and down the driver driving means with a small driving force and a force for putting a staple into sheets or paper by means of the driver is obtained by a small driving force. Moreover, a large turning force is generated in the clinch arm by the tension of the paper-thickness adjusting spring and the legs of the staple are clinched by the clinching means. Therefore, there is no correlation between precision of each component that determines an angle of turning of the clinch arm and a clinching angle of the legs of the staple. This prevents troubles such as insufficient clinching of the staple legs. In addition, load for turning the clinch arm is reduced by the rotation of the main driving means and load on the motor is also reduced.

Furthermore, it is possible to achieve size reduction and power saving because of small load applied on the motor. This allows the use of a battery as a power source.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIGS. 1A and 1B show the driving structure of an electric stapler according to an embodiment of the present invention, FIG. 1A being a plan view, and FIG. 1B being a side view;

FIG. 2A is a side view showing the state where sheets of paper are stapled by the driving structure, and FIG. 2B is a perspective view showing a structure of a paper-receiving table;

FIG. 3A is a perspective view of a toggle link mechanism, and FIG. 3B is a perspective view of a first link arm forming the toggle link mechanism;

FIG. 4 is a perspective view showing the structure of a clincher;

FIG. 5 is a diagram explaining an operation in which a cam pin provided in a clinch arm is displaced by a cam provided in a driving gear;

FIGS. 6A and 6B show the entire structure of an electric stapler of a conventional technique, FIG. 6A being a plan view, and FIG. 6B being a side view;

FIGS. 7A to 7C show the driving structure in the conventional electric stapler, FIG. 7A being a plan view, FIG. 7B being a side view, and FIG. 7C being a front view; and

FIGS. 8A to 8C show the structure of a clincher in the conventional electric stapler, FIG. 8A is a plan view, FIG. 8B being a front view, and FIG. 8C being a side view.

### DESCRIPTION OF THE PREFERRED EMBODIMENTS

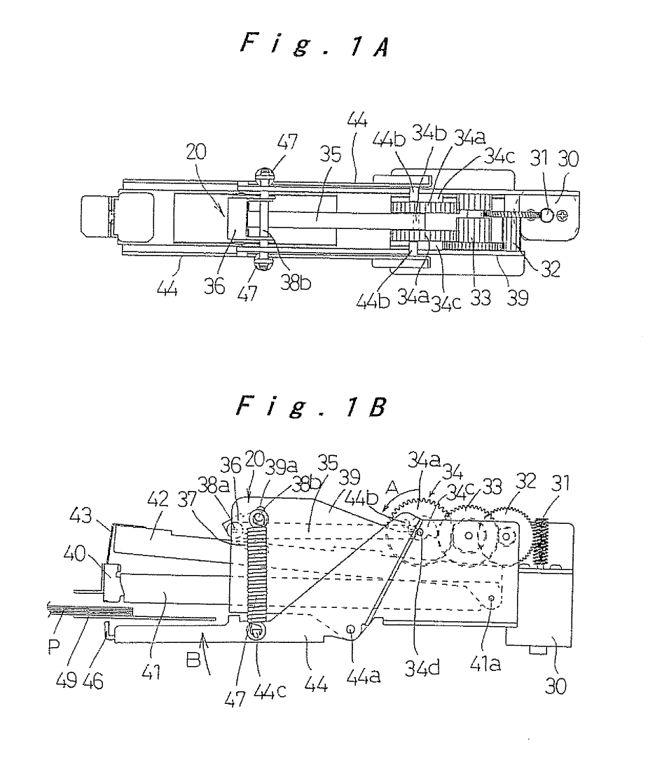

With reference to FIGS. 1A to 5, the invention will now be described based on the preferred embodiment, which does not intend to limit the scope of the invention, but exemplifies the invention.

FIGS. 1A to 3B show the structure of a driving mechanism that is a characteristic component of an electric stapler according to an embodiment of the present invention. A power-supply circuit and an outer package that are associated with the driving mechanism can be formed based on the conventional technique. Therefore, the power-supply circuit and the outer package are not shown in the drawings and the description thereof is omitted.

The electric stapler of the present embodiment is configured as follows. A motor 30 is used as a driving source. Rotation of the motor 30 drives a driving gear (main driving means) 34 which in turn causes a driver arm (driver driving means) 42 to oscillate up and down, thereby pushing one staple from a staple array accommodated in a staple magazine 40 by means of a driver 43 fixed to an oscillating end of the driver arm 42, putting the staple into sheets of paper P inserted onto a paper-receiving table 49 to penetrate through the sheets of paper 5, and clinching both legs of the staple penetrating through the sheets of paper P by means of a clincher (clinching means) 46. In this manner, the sheets of paper P are stapled together.

In FIGS. 1A and 1B, rotation of the motor 30 is transferred to the driving gear 34 from a worm gear 31 fixed to a rotation axis of the motor 30 through reduction gears 32 and 33. The driving gear 34 includes a pair of left and right gears 34a and 34a, as shown in FIG. 1A. The gears 34a are connected to each other with a connecting pin 34b at a position decentered from a rotation axis 34d. On outer side faces of the respective gears 34a, cams 34c are fixed to the rotation axis 34d. A connecting rod 35 is connected to the connecting pin 34b at one end in such a manner that the end of the connecting rod 35 is supported by the connecting pin 34b. When the connecting pin 34b located at the position decentered from the rotation axis 34d orbits around the rotation axis 34d due to the rotation of the driving gear 34, the connecting rod 35 performs a crank operation. The other end of the connecting rod 35 is connected to a toggle link mechanism 20 and therefore the crank operation of the connecting rod 35 drives the toggle link mechanism 20.

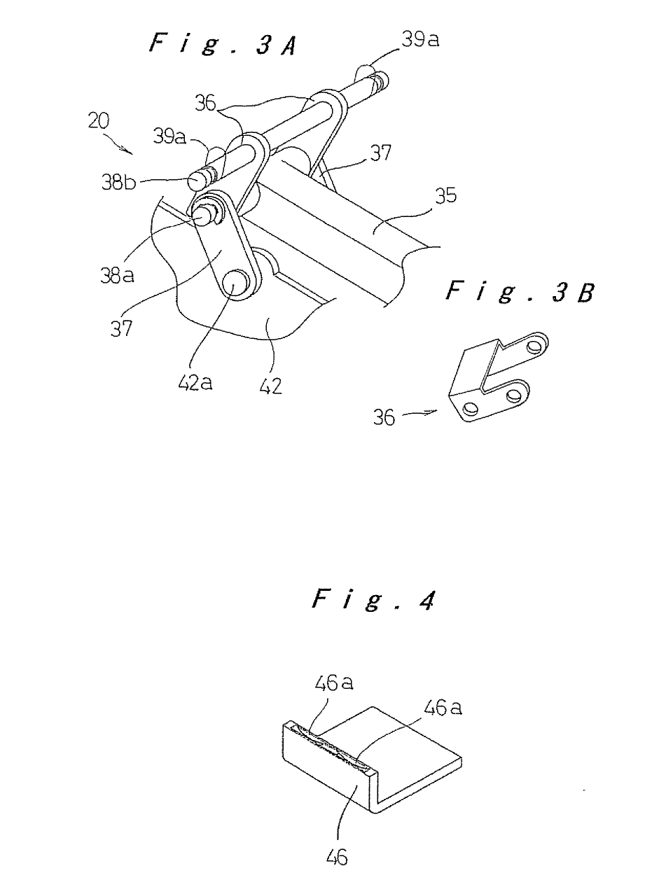

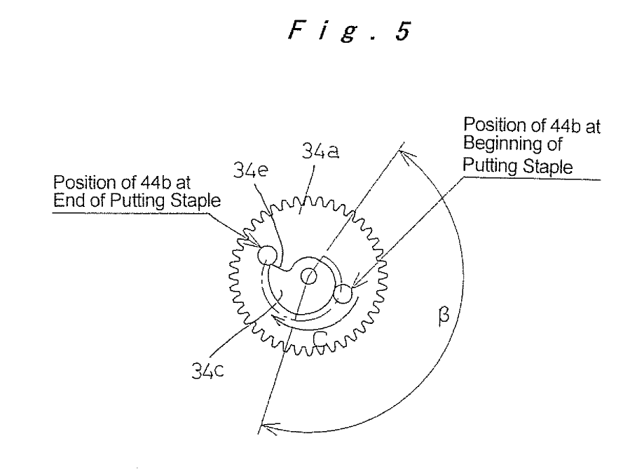

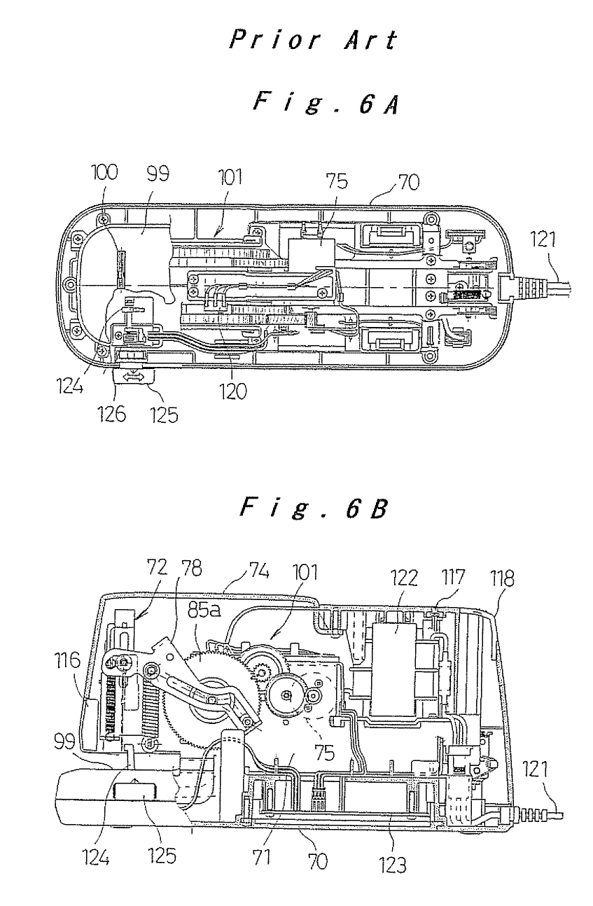

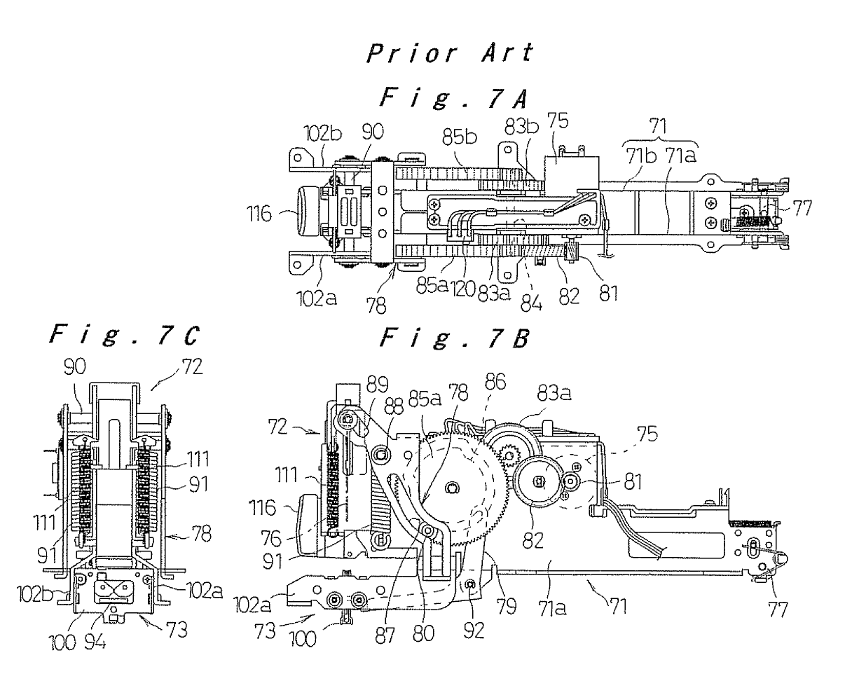

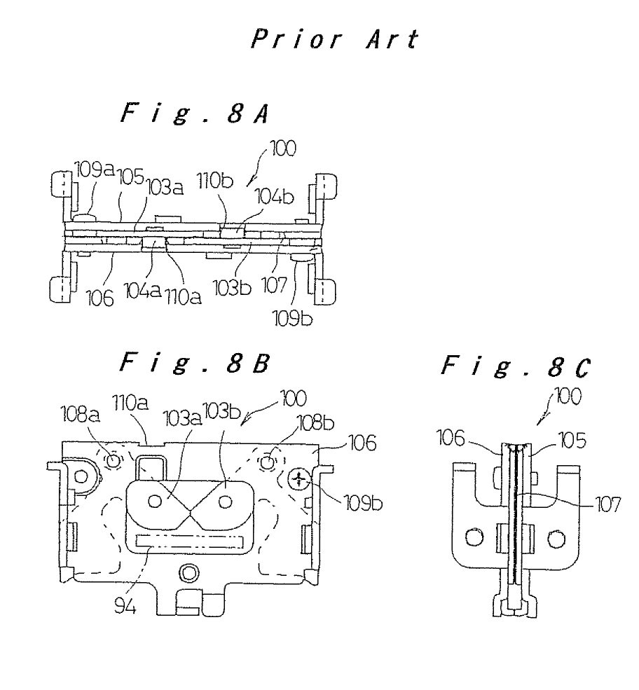

As shown in FIGS. 3A and 3B, in the toggle link mechanism 20, one end of a first link arm 36 having an about U-shaped cross-section and a pair of left and right arms, as shown in FIG. 3B, and one ends of second link arms 37 are supported by a turning shaft 38a that is provided at the other end of the connecting rod 35. The other ends of the first link arm 36 support a shaft 38b that has both ends fitted and inserted into elongate holes 39a respectively formed a pair of left and right stands 39. The other ends of the second link arms 37 are supported with a joint pin 42a on both side faces of the driver arm 42 to be freely turnable. By back-and-forth movement of the turning shaft 38a caused by the crank operation of the connecting rod 35, the toggle link mechanism 20 applies a larger pressing force to the driver arm 42 as the first link arm 36 and the second link arms 37 get closer to a straight line.

A clinch arm 44 is supported by the pair of left and right stands 39 at supports of turning 44a to be freely turnable. To one end of the clinch arm 44, the clincher 46 with a pair of U-shaped grooves 46a formed therein, as shown in FIG. 4, is attached and fixed. To the other end of the clinch arm 44, a cam pin 44b that is in contact with the cams 34c provided in the driving gear 34 is fixed. Paper-thickness adjusting springs 47 are provided between hooks 44c formed on both side faces of the clinch arm 44 and the ends of the shaft 38b.

A magazine holder 41 that detachably holds the driver arm 42 and the staple magazine 40 is supported by the stands 39 at its rear end with a common turning support 41a. In addition, the driver 43 for pushing one staple from a staple array accommodated in the staple magazine 40 is fixed to a top end of the driver arm 42.

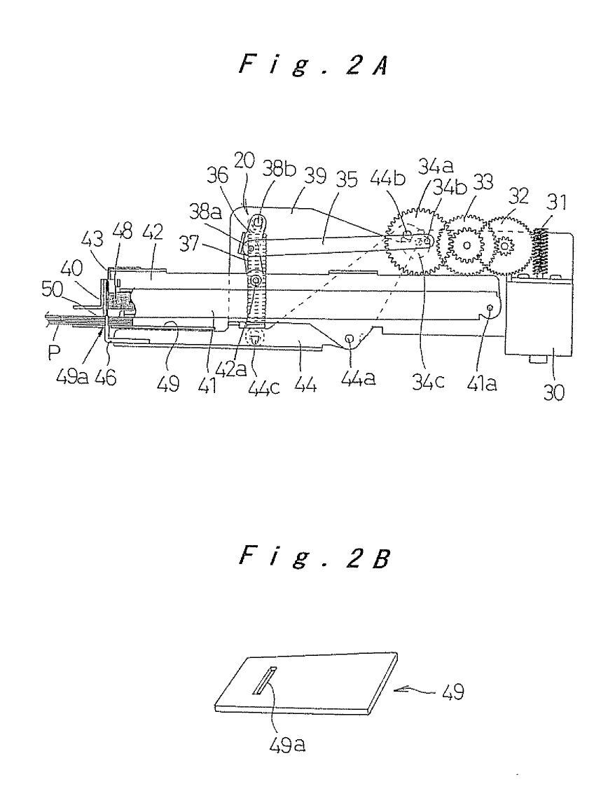

When sheets of paper P are inserted onto the paper-receiving table 49 of the electric stapler having the above structure, as shown in FIG. 1B, an activation switch (not shown) operates by insertion of the sheets of paper P and rotation of the motor 30 starts. The rotation of the motor 30 drives the driving gear 34 to rotate in a direction shown with arrow A in FIG. 1B, so that the connecting rod 35 fitted with the connecting pin 34b applies a pulling force in a direction in which an angle formed by the first link arm 36 and the second link arms 37 of the toggle link mechanism 20 becomes larger by the crank operation Thus, the driver arm 42 turns downward and causes to the magazine holder 41 to turn downward. As a result, as shown in FIG. 2A, the magazine holder 41 holds and compresses the inserted sheets of paper P against the paper-receiving table 49, and the driver 43 fixed to the driver arm 42 pushes out one staple 50 from a staple array 48 accommodated in the staple magazine 40 and puts the staple 50 into the sheets of paper P to make both legs of the staple 50 penetrate through the sheets of paper P. Since an opening 49a that allows the clincher 46 for clinching both legs of the staple 50 penetrating through the sheets of paper P to pass therethrough is formed in the paper-receiving table 49, as shown in FIG. 2B, the legs of the staple 50 penetrating through the sheets of paper P project into the opening 49a.

The connecting rod 35 continues to move in the direction in which the angle formed by the first link arm 36 and the second link arms 37 of the toggle link mechanism 20 becomes larger, even after the driver 43 reaches a position at which the staple 50 is put into the sheets of paper P. Thus, the shaft 38b that is fitted and inserted into the first ink arm 36 moves up within the elongate holes 39a formed in the stands 39, thereby stretching the paper-thickness adjusting springs 47. The stretched amount of the paper-thickness adjusting springs 47 changes in accordance with the thickness of the sheets of paper P. When the sheets of paper P are thin, a timing at which the driver 43 puts the staple 50 into the sheets of paper P is delayed. Thus, the moving amount of the shaft 38b is small and the stretched amount of the paper-thickness adjusting springs 47 is also small. Therefore, even if the moving amount of the connecting rod 35 is constant, putting of the staple 50 is done in accordance with change in the thickness of the sheets of paper P.

The clinch arm 44 supported by the stands 39 to be turnable is biased by tension of the paper-thickness adjusting springs 47 toward a direction shown with arrow B in FIG. 1B. Thus, at the beginning of putting of the staple 50 shown in FIGS. 1A and 1B, the cam pin 44b is in contact with the cams 34c provided in the driving gear 34 at the shown position and the clincher 46 attached and fixed to the top end of the clinch arm 44 is located under the paper-receiving table 49. When the driving gear 34 rotates in the direction shown with arrow A, a formed radius of the cam 34c increases, as shown in FIG. 5, and therefore the clinch arm 44 turns toward a direction opposite to arrow B.

FIG. 5 illustrates a state where a position of the cam pin 44b of the clinch arm 44 that is in contact with the cams 34c rotating together with the driving gear 34 is changed with rotation of the cams 34c. The cam pin 44b is moved outward with increase of the formed radius of the cams 34c along a trajectory shown with dashed line. When putting of the staple 50 by means of the driver 43 is finished, as shown in FIG. 2A, the cam pin 44b reaches a position 34e at which the formed radius of the cams 34c drastically decreases and gets into a portion having the smallest formed radius. Thus, the clinch arm 44 turns toward the direction of arrow B by the tension of the paper-thickness adjusting springs 47, so as to move the clincher 46 toward the opening 49a of the paper-receiving table 49. This movement of the clincher 46 brings the U-shaped grooves 46 into contact with both legs of the staple 50 that penetrate through the sheets of paper P and project into the opening 49a. Thus, the legs or the staple 50 are clinched along the U-shaped grooves 46a and the sheets of paper P are stapled together with the staple 50.

The driving gear 34 continues to rotate after the clinching operation is finished. Thus, the connecting rod 35 moves from the position shown in FIG. 2A in a direction in which the angle formed by the first link arm 36 and the second link arms 37 of the toggle link mechanism 20 becomes smaller. Therefore, the driver arm 42 turns upward. When the driver arm 42 is returned to the position shown in FIG. 13, a stop switch (not shown) operates to stop the rotation of the motor 30.

As described above, the electric stapler of the present embodiment turns the clinch arm 44 by the tension of the paper-thickness adjusting springs 47 and clinches both legs of the staple 50 by means of the clincher 46 attached to the clinch arm 44. Thus, there is no correlation between precision of each component that determines a turning angle of the clinch arm 44 and a clinching angle of the legs of the staple 50. This prevents troubles such as insufficient clinching of the staple legs.

Moreover, the cams 34c provided in the driving gear 34 have a function of moving the clinch arm 44 from a position at which the staple 50 is clinched to a standby position. It is enough to perform that operation within a time from start of putting of the staple 50 into the sheets of paper P by driving the motor 30 until the staple 50 is clinched. Thus, an angle of rotation or the driving gear 34 corresponds to an angle β shown in FIG. 5. This angle is larger, as compared with an angle of turning of the clinch arm after the staple is put in the conventional technique. Thus, load per angle is reduced and load applied to the motor 30 is also reduced. Moreover, load applied to the cam 34c is reduced. Therefore, it is not necessary to form the driving gear 34 including the cams 34c from a material having particularly high strength. That is, it is possible to use a material generally used.

The clincher 46 with the U-shaped grooves 46a formed therein is applied to the structure in -he aforementioned embodiment. Alternatively, a clinching mechanism using a pair of movable clinching plates described in the conventional technique may be applied.

As described above, according to the present invention, it is possible to reduce a driving force for putting a staple into sheets of paper and a driving force for clinching both legs of the staple penetrating through the sheets of paper. Therefore, an electric stapler in which load on a motor is small and size reduction and power saving are achieved is provided. Moreover, the electric stapler is hardly affected by precision or process and assembly of respective components. Therefore, the components are formed from a generally used material and the cost of the electric stapler is reduced.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. An electric stapler comprising:
main driving means being driven to rotate by a driving force from a motor;
driver driving means being moved up and down by a toggle link mechanism working with rotation of the main driving means;
a driver pushing out one staple from a staple array accommodated in a staple magazine, and putting the staple into sheets of paper by downward movement of the driver driving means;
a clinch arm turning in connection with the rotation of the main driving means;
a paper-thickness adjusting spring having an end connected to the toggle link mechanism and another end connected to the clinch arm; and
clinching means clinching both legs of the staple that is put into the sheets of paper by the driver to penetrate through the sheets of paper, by turning of the clinch arm and tension of the paper-thickness adjusting spring.
